(19) United States
(12) Patent Application Publication
(10) Pub. No.: US 2021/0175539 A1
(43) Pub. Date: Jun. 10, 2021

(54) ANODE-LESS ALL-SOLID-STATE BATTERY

(71) Applicants: HYUNDAI MOTOR COMPANY, Seoul (KR); KIA MOTORS CORPORATION, Seoul (KR)

(72) Inventors: Sang Heon Lee, Yongin-si (KR); Hoon Seok, Suwon-si (KR); Tae Young Kwon, Daegu (KR); Jae Min Lim, Suwon-si (KR); Sang Mo Kim, Hwaseong-si (KR)

(21) Appl. No.: 16/871,196

(22) Filed: May 11, 2020

(30) Foreign Application Priority Data
Dec. 6, 2019 (KR) 10-2019-0161234

(51) Int. Cl. H01M 10/0562; H01M 4/66

(52) U.S. Cl. CPC H01M 10/0562; H01M 2004/021; H01M 4/661; H01M 4/665

(57) ABSTRACT

An anode-less all-solid-state battery includes a porous layer that is able to occlude and release lithium, rather than a typical composite anode including an anode active material, thereby greatly improving the energy density thereof. The all-solid-state battery includes an anode current collector layer, a porous layer provided on at least one surface of the anode current collector layer and configured to include a three-dimensionally interconnected framework so as to form pores therein, a solid electrolyte layer provided on the porous layer, and a composite cathode layer provided on the solid electrolyte layer, in which a seed material is provided at an interface between the anode current collector layer and the porous layer and at an interface between the porous layer and the solid electrolyte layer.

### CROSS REFERENCE TO RELATED APPLICATIONS

The present application claims priority based on Korean Patent Application No. 10-2019-0161234, filed on Dec. 6, 2019, the entire content of which is incorporated herein for all purposes by this reference.

### BACKGROUND

### 1. Technical Field

The present disclosure relates to an anode-less all-solid-state battery, and more particularly to an all-solid-state battery, which includes a porous layer that is able to occlude and release lithium, rather than a typical composite anode including an anode active material, thereby greatly improving the energy density thereof.

### 2. Description of the Related Art

Rechargeable secondary batteries are used not only for small-sized electronic devices such as mobile phones, laptop computers and the like but also for large-sized transport vehicles such as hybrid vehicles, electric vehicles and the like. Accordingly, there is a need to develop secondary batteries having higher stability and energy density.

Conventional secondary batteries are mostly configured such that cells are formed using an organic solvent (organic liquid electrolyte), and thus limitations are imposed on the extent to which the stability and energy density thereof may be improved.

Meanwhile, an all-solid-state battery using an inorganic solid electrolyte is receiving a great deal of attention these days because a cell may be manufactured in a safer and simpler manner because an organic solvent is obviated.

However, the all-solid-state battery is problematic in that the energy density and power output performance thereof do not match those of conventional lithium-ion batteries using a liquid electrolyte. With the goal of solving the above problem, thorough research into improving the electrodes of all-solid-state batteries is ongoing.

In particular, the anode for an all-solid-state battery is mainly formed of graphite. In this case, ionic conductivity may be ensured when adding an excess of a solid electrolyte having a large specific gravity, together with graphite, and thus the energy density per unit weight is very low compared to lithium-ion batteries. Moreover, when lithium metal is used for the anode, there are technical limitations in terms of price competitiveness and large-scale implementation.

### SUMMARY

Accordingly, an objective of the present disclosure is to provide an all-solid-state battery having greatly improved energy density per unit weight and energy density per unit volume.

The objectives of the present disclosure are not limited to the foregoing, and will be able to be clearly understood through the following description and to be realized by the means described in the claims and combinations thereof.

An embodiment of the present disclosure provides an all-solid-state battery, including an anode current collector layer, a porous layer provided on at least one surface of the anode current collector layer and configured to include a three-dimensionally interconnected framework so as to form pores therein, a solid electrolyte layer provided on the porous layer, and a composite cathode layer provided on the solid electrolyte layer, in which a seed material is provided at an interface between the anode current collector layer and the porous layer and at an interface between the porous layer and the solid electrolyte layer.

The anode current collector layer may include a metal selected from the group consisting of copper, nickel and combinations thereof.

The anode current collector layer may have a porosity of less than 1%, or a thickness of 1 μm to 20 μm.

The framework may include a metal selected from the group consisting of copper, nickel and combinations thereof.

The porous layer may have a thickness of 1 μm to 100 μm, or a porosity of 10% to 99%.

The porous layer may further include at least one selected from among an ionic liquid, a binder and a solid electrolyte, which are loaded in the pores.

The porous layer may have a multilayer structure.

The porous layer having the multilayer structure may be configured such that a pore size of a layer in contact with the anode current collector layer is greater than a pore size of a layer in contact with the solid electrolyte layer.

The seed material may be provided at an interface between layers of the porous layer.

The composite cathode layer may include a cathode active material layer provided on the solid electrolyte layer and a cathode current collector layer provided on the cathode active material layer.

The seed material may be selected from the group consisting of lithium (Li), indium (In), gold (Au), bismuth (Bi), zinc (Zn), aluminum (Al), iron (Fe), tin (Sn), titanium (Ti) and combinations thereof.

The seed material may be provided through deposition or coating on at least one surface of at least one layer of the anode current collector layer and the porous layer.

The seed material may be provided so as not to completely cover the interface.

The seed material may be uniformly distributed at the interface so as to occupy 1% to 50% of an area of the interface.

The all-solid-state battery may include a 3-electrode cell configured such that the composite cathode layer, the solid electrolyte layer, the porous layer, the anode current collector layer, the porous layer, the solid electrolyte layer and the composite cathode layer are sequentially stacked.

According to the present disclosure, the energy density per unit weight of the all-solid-state battery and the energy density per unit volume thereof can be greatly improved.

According to the present disclosure, the all-solid-state battery does not include an anode active material such as graphite, etc., and thus the lifetime thereof can be significantly increased because there is no volume expansion of the anode during charging and discharging.

The effects of the present disclosure are not limited to the foregoing, and should be understood to include all effects that can be reasonably anticipated from the following description.

### BRIEF DESCRIPTION OF THE FIGURES

FIG. 1A shows an all-solid-state battery according to a first embodiment of the present disclosure;

FIG. 1B is an enlarged view of region A of FIG. 1A;

FIG. 1C is an enlarged view of region B of FIG. 1A;

FIG. 2 schematically shows the porous layer of the all-solid-state battery;

FIG. 3A shows an all-solid-state battery according to a modification of the first embodiment of the present disclosure;

FIG. 3B is an enlarged view of region C of FIG. 3A;

FIG. 4 is a top plan view showing an anode current collector layer and a seed material formed on the surface thereof according to the present disclosure;

FIG. 5 shows an all-solid-state battery according to a second embodiment of the present disclosure; and

FIG. 6 shows an all-solid-state battery according to a modification of the second embodiment of the present disclosure.

### DETAILED DESCRIPTION

The above and other objectives, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting the measurements that essentially occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

An anode provided in a conventional all-solid-state battery includes an anode active material such as graphite, etc. Also, an excess of solid electrolyte is added therewith in order to ensure ionic conductivity in the anode. Consequently, the volume and weight of the anode may increase, undesirably lowering the energy density thereof.

Moreover, graphite, which is the anode active material, increases the range of volume expansion and shrinkage during charging and discharging of batteries, and thus short-circuits may occur in the anode and resistance may increase, undesirably reducing the lifetime of batteries.

Meanwhile, lithium metal may be used as the anode for the all-solid-state battery, and lithium metal is expensive and has a slow reaction rate. Also, problems such as short-circuits due to the growth of dendrites and difficulties in realizing a large area may occur.

Accordingly, the present disclosure has been made keeping in mind the above conventional problems, and the present disclosure is described in detail below.

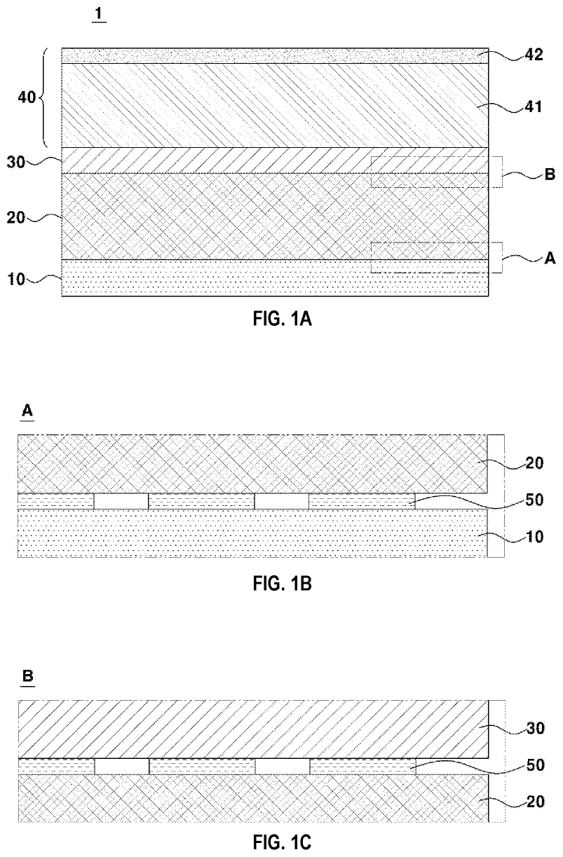

FIG. 1A shows an all-solid-state battery 1 according to a first embodiment of the present disclosure. With reference thereto, the all-solid-state battery 1 may include an anode current collector layer 10, a porous layer 20 provided on at least one surface of the anode current collector layer 10, a solid electrolyte layer 30 provided on the porous layer, and a composite cathode layer 40 provided on the solid electrolyte layer.

The anode current collector layer 10 may be a kind of sheet-shaped substrate.

The anode current collector layer 10 may be a metal thin film including a metal selected from the group consisting of copper (Cu), nickel (Ni) and combinations thereof. Specifically, the anode current collector layer 10 may be a high-density metal thin film having a porosity of less than about 1%.

The anode current collector layer 10 may have a thickness of 1 μm to 20 μm, and particularly 5 μm to 15 μm.

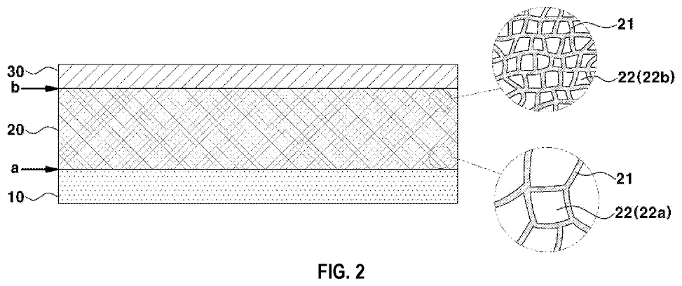

FIG. 2 schematically shows the porous layer 20 of the all-solid-state battery 1. The porous layer 20 is a layer that includes therein pores 22 for storing lithium that precipitates during charging of the all-solid-state battery 1, and may include a three-dimensionally interconnected framework 21 so as to form the pores 22 therein.

The framework 21 is the skeleton of the porous layer 20, and may include a metal selected from the group consisting of copper (Cu), nickel (Ni) and combinations thereof.

As shown in FIG. 2, the porous layer 20 includes a first surface a in contact with the anode current collector layer 10 and a second surface b in contact with the solid electrolyte layer 30. Here, the pores 22 may be non-uniformly distributed in the thickness direction of the porous layer 20 such that the pores 22a positioned in the first surface a are larger than the pores 22b positioned in the second surface b. As such, non-uniform distribution of the pores 22 means that the pores 22 having different diameters are distributed in the thickness direction of the porous layer 20, which may be variously embodied. For example, the size of the pores 22 may gradually increase from the second surface b to the first surface a, or the size of the pores 22b in the second surface b may be maintained up to a predetermined thickness and may then increase stepwise when reaching the first surface a.

When the size of the pores 22a positioned in the first surface a is greater in this way, lithium that precipitates during charging of the all-solid-state battery 1 may be stored in a larger amount in the first surface a, particularly in the anode current collector layer 10. Since the lithium comes into contact with the large area of the anode current collector layer 10, the lithium may be more easily converted into lithium ions during discharging of the all-solid-state battery, thereby increasing charge-discharge efficiency.

The average diameter of the pores 22 is not particularly limited, and may be, for example, 0.01 μm to 5 μm. Here, the average diameter of the pores 22 may mean the average diameter of the pores 22 included in the entire porous layer 20. As described above, when the pores are non-uniformly distributed in the thickness direction of the porous layer 20, the average diameter thereof may indicate an average diameter of pores 22 falling within a reasonable thickness range.

The porous layer 20 may have a thickness of 1 μm to 100 μm and a porosity of 10% to 99%. When the thickness and porosity of the porous layer 20 fall in the above ranges, the energy density of the all-solid-state battery may be greatly improved.

The porous layer 20 may further include at least one selected from among an ionic liquid (not shown), a binder (not shown) and a solid electrolyte (not shown), which are loaded in the pores 22.

The ionic liquid and the solid electrolyte may be responsible for the movement of lithium ions in the porous layer 20, and the binder may be a kind of adhesive material that interconnects components of the porous layer 20.

The amount of each of the ionic liquid, the solid electrolyte and the binder is not particularly limited and may be appropriately adjusted as desired.

The ionic liquid is not particularly limited, but may be selected from the group consisting of imidazolium-based, ammonium-based, pyrrolidinium-based, pyridinium-based, and phosphonium-based ionic liquids and combinations thereof.

The solid electrolyte may be an oxide-based solid electrolyte or a sulfide-based solid electrolyte. Here, the use of a sulfide-based solid electrolyte having high lithium ionic conductivity is preferable. The sulfide-based solid electrolyte is not particularly limited, but may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (in which m and n are positive numbers, and Z is any one of Ge, Zn and Ga), Li₂S—GeS₂, Li₂S—SiS₂—Li₃PO₄, Li₂S—SiS₂—LiₓMO_{y} (in which x and y are positive numbers, and M is any one of P, Si, Ge, B, Al, Ga and In), Li₁₀GeP₂S₁₂, etc. The oxide-based solid electrolyte may include a garnet-type solid electrolyte, a NASICON-type solid electrolyte, a LISICON-type solid electrolyte, a perovskite-type solid electrolyte, etc.

The binder is not particularly limited, but may include BR (butadiene rubber), NBR (nitrile butadiene rubber), HNBR (hydrogenated nitrile butadiene rubber), PVDF (polyvinylidene difluoride), PTFE (polytetrafluoroethylene), CMC (carboxymethylcellulose), etc.

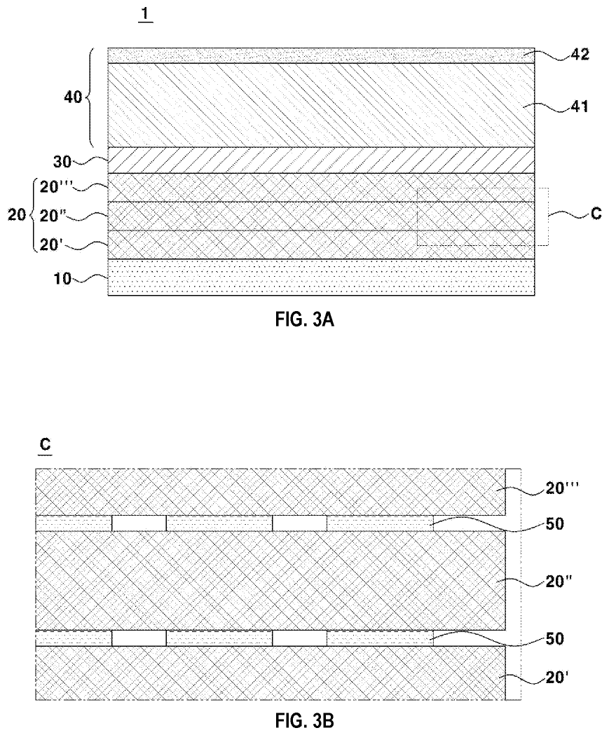

FIG. 3A shows an all-solid-state battery 1 according to a modification of the first embodiment of the present disclosure. With reference thereto, the porous layer 20 may have a multilayer structure 20′, 20″, 20′″.

When the porous layer 20 has a monolayer structure, the thickness of the porous layer 20 may not be uniform, and lithium may be non-uniformly stored in the porous layer 20. Hence, the above problems may be prevented from occurring by forming the porous layer 20 having a multilayer structure 20′, 20″, 20′″.

The porous layer 20 may be configured such that the pore size of the layer 20′ in contact with the anode current collector layer 10 is greater than the pore size of the layer 20′″ in contact with the solid electrolyte layer 30. When the multilayer structure of the porous layer 20 is formed as above, lithium that precipitates during charging of the all-solid-state battery 1 may be stored in a larger amount in the anode current collector layer 10. Since the lithium comes into contact with the large area of the anode current collector layer 10, the lithium may be more easily converted into lithium ions during discharging of the all-solid-state battery, thereby increasing charge-discharge efficiency.

FIG. 3B is an enlarged view of region C of FIG. 3A. With reference thereto, a seed material 50 may be provided at interfaces between the layers 20′, 20″, 20′″ of the porous layer 20. Accordingly, lithium may also be precipitated in the porous layer 20, which is described later.

The solid electrolyte layer 30 is interposed between the porous layer 20 and the composite cathode layer 40 so that lithium ions may move between the two layers.

The solid electrolyte layer 30 may include an oxide-based solid electrolyte or a sulfide-based solid electrolyte. Here, the use of a sulfide-based solid electrolyte having high lithium ionic conductivity is preferable. The sulfide-based solid electrolyte is not particularly limited, but may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (in which m and n are positive numbers, and Z is any one of Ge, Zn and Ga), Li₂S—GeS₂, Li₂S—SiS₂—Li₃PO₄, Li₂S—SiS₂—LiₓMO_{y} (in which x and y are positive numbers, and M is any one of P, Si, Ge, B, Al, Ga and In), Li₁₀GeP₂S₁₂, etc. The oxide-based solid electrolyte may include a garnet-type solid electrolyte, a NASICON-type solid electrolyte, a LISICON-type solid electrolyte, a perovskite-type solid electrolyte, etc.

The composite cathode layer 40 may include a cathode active material layer 41 provided on the solid electrolyte layer 30 and a cathode current collector layer 42 provided on the cathode active material layer 41.

The cathode active material layer 41 may include a cathode active material, a solid electrolyte, a conductive material, a binder, etc.

The cathode active material may be an oxide active material or a sulfide active material.

The oxide active material may be a rock-salt-layer-type active material such as LiCoO₂, LiMnO₂, LiNiO₂, LiVO₂, Li₁₊ₓNi_{1/3}Co_{1/3}Mn_{1/3}O₂ and the like, a spinel-type active material such as LiMn₂O₄, Li(Ni_{0.5}Mn_{1.5})O₄ and the like, an inverse-spinel-type active material such as LiNiVO₄, LiCoVO₄ and the like, an olivine-type active material such as LiFePO₄, LiMnPO₄, LiCoPO₄, LiNiPO₄ and the like, a silicon-containing active material such as Li₂FeSiO₄, Li₂MnSiO₄ and the like, a rock-salt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}M_{y}O₄ (M being at least one of Al, Mg, Co, Fe, Ni and Zn, 0<x+y<2), or lithium titanate such as Li₄Ti₅O₁₂ and the like.

The sulfide active material may be copper chevrel, iron sulfide, cobalt sulfide, nickel sulfide, etc.

The solid electrolyte may be an oxide-based solid electrolyte or a sulfide-based solid electrolyte. Here, the use of a sulfide-based solid electrolyte having high lithium ionic conductivity is preferable. The sulfide-based solid electrolyte is not particularly limited, but may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (in which m and n are positive numbers, and Z is any one of Ge, Zn and Ga), Li₂S—GeS₂, Li₂S—SiS₂—Li₃PO₄, Li₂S—SiS₂—LiₓMO_{y} (in which x and y are positive numbers, and M is any one of P, Si, Ge, B, Al, Ga and In), Li₁₀GeP₂S₁₂, etc. The oxide-based solid electrolyte may include a garnet-type solid electrolyte, a NASICON-type solid electrolyte, a LISICON-type solid electrolyte, a perovskite-type solid electrolyte, etc. The solid electrolyte may be the same as or different from the solid electrolyte included in the solid electrolyte layer 30.

The conductive material may be carbon black, conductive graphite, ethylene black, graphene, etc.

The binder may be BR (butadiene rubber), NBR (nitrile butadiene rubber), HNBR (hydrogenated nitrile butadiene rubber), PVDF (polyvinylidene difluoride), PTFE (polytetrafluoroethylene), CMC (carboxymethylcellulose), etc., and may be the same as or different from the binder included in the porous layer 20.

The cathode current collector layer 42 may be an aluminum foil or the like.

FIG. 1B is an enlarged view of region A of FIG. 1A, and FIG. 1C is an enlarged view of region B of FIG. 1A. With reference thereto, the all-solid-state battery 1 may be configured such that the seed material 50 is provided at the interface between the anode current collector layer 10 and the porous layer 20 and at the interface between the porous layer 20 and the solid electrolyte layer 30.

With reference to FIG. 3B, when the all-solid-state battery 1 includes the porous layer 20 having the multilayer structure, the seed material 50 may be provided at interfaces between the layers 20′, 20″, 20′″ of the porous layer, in addition to the above interfaces.

The seed material 50 functions as a kind of seed for the lithium ions moving to the porous layer 20 during charging of the all-solid-state battery 1. When the all-solid-state battery 1 is charged, the lithium ions grow into lithium around the seed material 50.

The seed material 50 may include a metal element that may be alloyed with lithium. Specifically, it may be selected from the group consisting of lithium (Li), indium (In), gold (Au), bismuth (Bi), zinc (Zn), aluminum (Al), iron (Fe), tin (Sn), titanium (Ti) and combinations thereof.

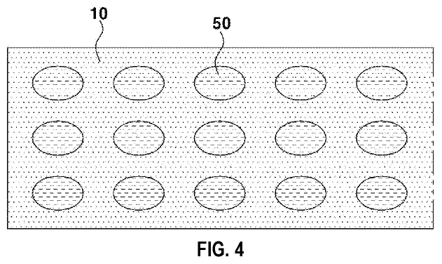

FIG. 4 is a top plan view showing an anode current collector layer 10 and a seed material 50 formed on the surface thereof according to the present disclosure. The seed material 50 may be provided through deposition or coating in a predetermined shape on at least one surface of at least one layer of the anode current collector layer 10 and the porous layer 20.

Specific embodiments for forming the seed material 50 are not particularly limited. The seed material 50 may be formed on the surface of a suitable layer so that the seed material 50 may be formed at positions shown in FIGS. 1B, 1C, and 3B.

The process of forming the seed material 50 is not particularly limited. For example, a vapor deposition process such as physical vapor deposition (PVD) or chemical vapor deposition (CVD), or a coating process such as screen printing, gravure coating, inkjet coating, or the like may be performed.

The seed material 50 may be provided so as not to completely cover the above-described interfaces. That is, the seed material 50 does not form a series of layers. This is to prevent the seed material 50 from acting as resistance in the all-solid-state battery 1. Specifically, the seed material 50 is uniformly distributed on the above-described interface, but may be provided so as to occupy 1% to 50% of the area of the interface.

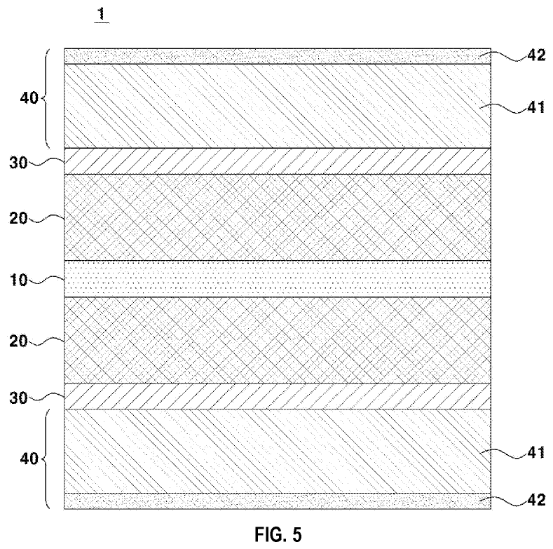

FIG. 5 shows an all-solid-state battery 1 according to a second embodiment of the present disclosure. With reference thereto, the all-solid-state battery 1 may include a 3-electrode cell configured such that a composite cathode layer 40, a solid electrolyte layer 30, a porous layer 20, an anode current collector layer 10, a porous layer 20, a solid electrolyte layer 30 and a composite cathode layer 40 are sequentially stacked. Since the specific content of each layer is substantially the same as that of the above-described first embodiment, it will be omitted below.

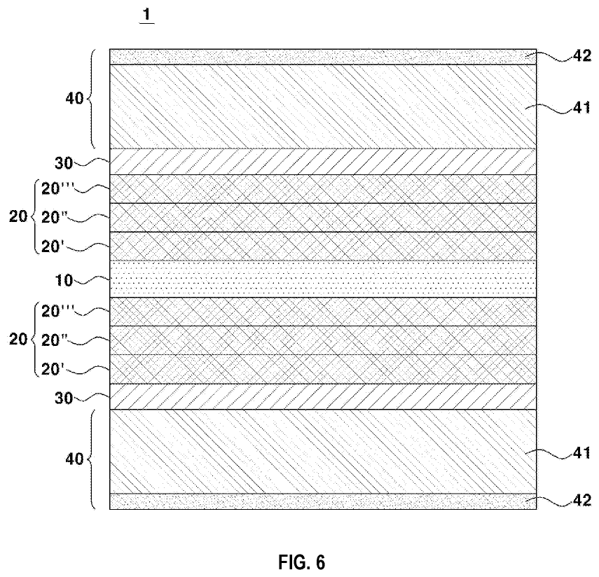

FIG. 6 shows an all-solid-state battery 1 according to a modification of the second embodiment of the present disclosure. With reference thereto, the porous layer 20 may have a multilayer structure 20′, 20″, 20′″. Since the specific content of each layer is substantially the same as that of the above-described first embodiment, it will be omitted below.

In order to increase the energy density per unit weight of the all-solid-state battery and the energy density per unit volume thereof, the present disclosure provides a kind of anode-less all-solid-state battery configured such that a porous layer 20 is provided on an anode current collector layer 10, without the use of an anode including an anode active material as in a conventional all-solid-state battery.

In particular, when the porous layer 20 having high porosity is used in the present disclosure, the energy density can be greatly increased to 400 Wh/kg (800 Wh/l) or more, which is approximately double that of a conventional lithium-ion battery.

Although specific embodiments of the present disclosure have been described with reference to the accompanying drawings, those skilled in the art will appreciate that the present disclosure may be embodied in other specific forms without changing the technical spirit or essential features thereof. Thus, the embodiments described above should be understood to be non-limiting and illustrative in every way.

1. An all-solid-state battery, comprising:
an anode current collector layer;
a porous layer provided on at least one surface of the anode current collector layer and configured to include a three-dimensionally interconnected framework so as to form pores therein;
a solid electrolyte layer provided on the porous layer; and
a composite cathode layer provided on the solid electrolyte layer,
wherein a seed material is provided at an interface between the anode current collector layer and the porous layer and at an interface between the porous layer and the solid electrolyte layer.

2. The all-solid-state battery of claim 1, wherein the anode current collector layer is a metal thin film comprising a metal selected from the group consisting of copper, nickel and combinations thereof.

3. The all-solid-state battery of claim 1, wherein the anode current collector layer has a porosity of less than 1%.

4. The all-solid-state battery of claim 1, wherein the anode current collector layer has a thickness of 1 μm to 20 μm.

5. The all-solid-state battery of claim 1, wherein the framework comprises a metal selected from the group consisting of copper, nickel and combinations thereof.

6. The all-solid-state battery of claim 1, wherein the porous layer has a thickness of 1 μm to 100 μm.

7. The all-solid-state battery of claim 1, wherein the porous layer has a porosity of 10% to 99%.

8. The all-solid-state battery of claim 1, wherein the porous layer further comprises at least one selected from among an ionic liquid, a binder and a solid electrolyte, which are loaded in the pores.

9. The all-solid-state battery of claim 1, wherein the porous layer has a multilayer structure.

10. The all-solid-state battery of claim 9, wherein the porous layer having the multilayer structure is configured such that a pore size of a layer in contact with the anode current collector layer is greater than a pore size of a layer in contact with the solid electrolyte layer.

11. The all-solid-state battery of claim 9, wherein the seed material is provided at an interface between layers of the porous layer.

12. The all-solid-state battery of claim 1, wherein the composite cathode layer comprises a cathode active material layer provided on the solid electrolyte layer and a cathode current collector layer provided on the cathode active material layer.

13. The all-solid-state battery of claim 1, wherein the seed material is selected from the group consisting of lithium (Li), indium (In), gold (Au), bismuth (Bi), zinc (Zn), aluminum (Al), iron (Fe), tin (Sn), titanium (Ti) and combinations thereof.

14. The all-solid-state battery of claim 1, wherein the seed material is provided through deposition or coating on at least one surface of at least one layer of the anode current collector layer and the porous layer.

15. The all-solid-state battery of claim 1, wherein the seed material is provided so as not to completely cover the interface.

16. The all-solid-state battery of claim 1, wherein the seed material is uniformly distributed at the interface so as to occupy 1% to 50% of an area of the interface.

17. The all-solid-state battery of claim 1, which comprises a 3-electrode cell configured such that the composite cathode layer, the solid electrolyte layer, the porous layer, the anode current collector layer, the porous layer, the solid electrolyte layer and the composite cathode layer are sequentially stacked.
